(19) United States
(12) Patent Application Publication
(10) Pub. No.: US 2007/0183609 A1
(43) Pub. Date: Aug. 9, 2007

(54) HEARING AID SYSTEM WITHOUT MECHANICAL AND ACOUSTIC FEEDBACK

(76) Inventor: Paul Chung Cheng Jenn, San Diego, CA (US)

Correspondence Address: Lin Yu, 11597 Tree Hollow Lane, San Diego, CA, 92128, US

(21) Appl. No.: 11/614,968

(22) Filed: Dec. 21, 2006

Related U.S. Application Data
(60) Provisional application No. 60/753,468, filed on Dec. 22, 2005.

(51) Int. Cl. H04R 25/00

(52) U.S. Cl. 381/312

(57) ABSTRACT

The present invention relates to a hearing aid system which comprises a microphone earpiece on a first ear of a hearing impaired individual for receiving audio input signals, a portable signal process unit for processing the signals for clarity and fidelity of the sound, and a receiver earpiece on a second hearing impaired ear for delivering the audio output signals to compensate for the individual's hearing impairment. The design of the hearing aid system eliminates both mechanical and acoustic feedbacks, and thus significantly simplifies the hearing aid fitting process.

### CROSS-REFERENCE TO OTHER APPLICATION

This application claims the benefit of U.S. Provisional Application No. 60/753,468, filed on Dec. 22, 2005.

### TECHNICAL FIELD

The present invention relates to a hearing aid system which comprises a microphone earpiece attached to the first ear of a hearing impaired individual for receiving audio input signals, a portable signal process unit for processing the audio signals for clarity and fidelity, and a receiver earpiece attached to the second hearing impaired ear to deliver amplified audio signals to compensate for the hearing impairment.

### BACKGROUND OF THE INVENTION

Hearing aid devices are well-known in the art for compensating an individual hearing impairment. Hearing aid devices operate by amplifying detected sound to a level a hearing impaired individual can comprehend. The most common hearing aid devices today integrate a microphone and a receiver as all-in-one devices for convenience and cosmetic reasons. However, one of the major problems with such design is mechanical and acoustic feedback, an unpleasant acoustic squeal, variously described as “whistling”, “howling”, and “screeching”. Acoustic feedback frequently occurs in such all-in-one hearing aid devices and thus significantly limits the maximum gain that can be achieved. Industry estimates that 10 to 15 percent of in-the-ear hearing aids are returned within the first 30 days because of feedback problems, while surveys of hearing aid users implicate the presence of feedback as being one of their primary problem areas.

Acoustic feedback with a hearing aid occurs when a portion of the amplified sounds escapes from the ear canal, reach the microphone of the hearing aid, and get re-amplified. This action begins the feedback cycle of amplification and re-amplification of the same signals, resulting in acoustic squeal. Feedback is more likely to occur when high gain is required. Because more sound will escape from the ear canal with more powerful hearing aids, it will be the stronger aids that exhibit the most acoustic feedback. For the most powerful hearing aids, feedback may occur no matter how well the hearing aid is fitted to the hearing impaired individual to limit the amount of radiated sound.

There are certain conditions that will increase the chances of feedback for any all-in-one acoustic hearing aid, no matter how weak or powerful, including improperly seating an earmold into the bowl of the ear and ear canal, loose earmolds, increasing reflections off an eardrum. When the earmold is vented, usually for very appropriate acoustical or comfort reasons, the vent itself also becomes a channel for the sound to escape from the ear and be picked up by the microphone. The orientation of the earmold in the ear is also a factor. If the sound bore is pointed to the wall of the ear canal rather than to the eardrum, the likelihood of reflections and thus the presence of feedback are increased.

The problematic feedback also brings other inconveniences to hearing aid users. For example, some innocent common and routine physical activities, such as placing one's hands next to the hearing aid while adjusting the volume control, raising one's coat collar or pulling down a stocking cap on a cold day, standing close to a wall, resting one's head on a pillow, or using a telephone without a telephone coil, can facilitates the feedback cycle and thus also increase the chances of feedback. In these cases, the aid may be set just below the feedback point, but with the addition of these enhancement factors enough sound is reflected back into the microphone for the feedback cycle to commence.

The traditional solution to acoustic feedback has been to focus primarily on the earmold, to try to seal the amplified sound in the ear canal by strengthening or lengthening the otoplastic, or making the ventilation hole smaller. Another solution is to reduce either or both the gain of the hearing aid or its high frequency response. However, all those traditional solution are always to the detriment of the wear comfort and reproduction quality of the instrument.

More recently, several electronic solutions have been developed to reduce the occurrences of acoustic feedbacks but have limited successes. One solution is to reduce the high frequency gain of the hearing aid when feedback is sensed. This may indeed minimize acoustic feedback, but at the same time audibility at the high frequencies is also reduced. A variation on this method is the use of a notch filter. In a notch filter, only a narrow band of frequencies is reduced in gain. Such a system requires that the hearing aid includes an additional electronic circuit that can detect and measure the frequency of the squeal and then reduce the gain in a narrow band just around the offending frequency. Some hearing aids can do this adaptively, that is continually sampling the system for the presence of acoustic feedback and creates a notch filter whenever this occurs. However, this method also requires modifying the hearing aid's frequency response when feedback occurs. While such modifications may be minimal, audibility is still reduced somewhat. Still, this method of controlling feedback is likely to have much less of a negative effect than the signal distortions caused by acoustic feedback.

Another electronic solution is applying signal canceling technology to reduce acoustic feedback without any modifications in the basic response of the hearing aid. This type of circuit also depends upon a sensor circuit that can continually detect and monitor the occurrence of acoustic feedback. However, rather than using a notch filter to reduce the feedback, in this method a signal is created within the hearing aid which is equal to but opposite in phase to the feedback signal. When the two signals are added, the feedback signal is cancelled. Although these new advanced digital processing methods are effective in reducing the occurrences of acoustic feedback to certain extents, they all in one way or other alter tonal characteristics and compromise the audibility of the input sound signal, sometimes leading to unacceptable tonal deteriorations of the input audio signal. Additionally, these new sophisticated technologies also add additional financial burdens to the hearing impaired users due to the expenses associated with the much more expensive digital hearing aid device as well as the costs associated with the more time-consuming and complicated fitting processes which must be conducted by a specialist, such as an audiologist.

To address these problems, the present invention provides a simple and economical solution to eliminate both mechanical and acoustic feedback by simply separating the microphone and the receiver physically far enough to completely eliminate the conditions necessary for mechanical and acoustic feedback to occur. The hearing aid system of the present invention contains two earpieces: a microphone earpiece and a receiver earpiece. The microphone earpiece is worn on the first ear of a hearing impaired individual for receiving audio input signals whereas a receiver earpiece on the second impaired ear for delivering the audio output signals to compensate for the hearing impairment. Additionally, a portable signal process unit is also provided for processing the audio signals for clarity and fidelity of the sound, and controlling the functionalities of the hearing aid system. The hearing aid system of the present invention is much simpler in design than the sophisticated digital hearing devices and thus requires fewer electronic circuitries and components and much less sophisticated software programs to operate. As result, the hearing aid system with such design will be significantly economical to produce and require much less time to develop and upgrade. This simple design also will dramatically reduce the costs associated with the fitting process. Since the microphone and receiver are far apart in such design, there is no need for custom fitting by a specialist, thus further reducing the associated cost and increasing the affordability.

### SUMMARY OF THE INVENTION

In accordance with the present invention, a hearing aid system includes a microphone earpiece attached to a first ear of a hearing impaired user, a portable signal process unit, and a receiver earpiece attached to a second hearing impaired ear. The microphone earpiece receives audio input signals, converts the audio signals to transmittable signals, and delivers the transmittable signals to the process unit. The signal process unit receives and processes the transmittable signals for clarity and fidelity of the sound, generates processed signals according to a predetermined hearing profile of the user to compensate for the hearing impairment, and delivers the processed signals to the receiver earpiece. The receiver earpiece receives the processed signals and converts the processed signals to audio output signals.

The hearing aid system of the present invention is advantageous over conventional all-in-one hearing aid devices. By physically separating the microphone and receiver, it eliminates both mechanical and acoustic feedback, which is associated with nearly all commercial hearing aids. Such design also significantly simplifies the fitting process. As result, the microphone and receiver earpieces can be used as off-shelf products without the needs of custom-fitting by a specialist, such as an audiologist, as required for the conventional hearing aid devices.

### BRIEF DESCRIPTION OF THE DRAWINGS

FIG. 1 depict four exemplary embodiments of the hearing aid system of the present invention in block diagrams.

### DETAILED DESCRIPTION OF THE INVENTION

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

The hearing aid system 1 of the present invention contains one microphone earpiece 10, one signal process unit (also known as a signal processor) 20, and at least one receiver earpiece 30. As used herein, the terms “receiver” and “speaker are used interchangeably.

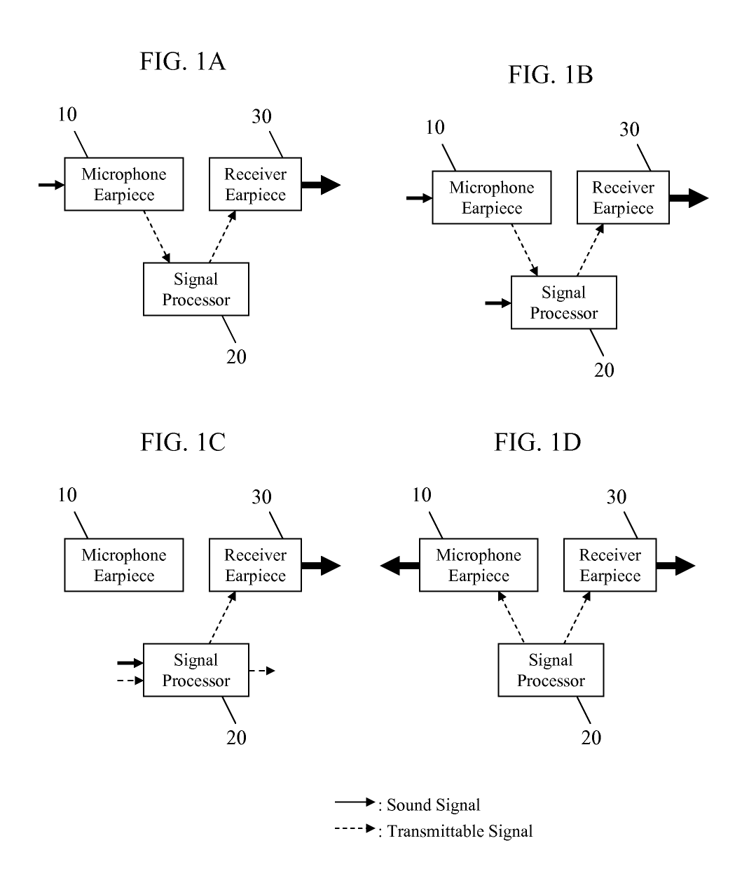

In one embodiment, the hearing aid system 1 is configured to receive sound signals only from the microphone earpiece 10 as shown in FIG. 1A. The microphone earpiece 10 (“input earpiece”) worn on a first ear of the hearing aid user receives audio input signals, converts the audio signals to transmittable signals, which may be analog or digital, and delivers the transmittable signals to the signal process unit 20. The portable signal process unit 20 receives and processes the transmittable signals to amplify the signals according to a predetermined hearing profile of the hearing aid user, generates processed signals (also known as amplified signals) for compensating for the user's hearing impairment. The signal process unit 20 delivers the processed signals to the receiver earpiece 30. The receiver earpiece 30 (“output earpiece”) worn on a second impaired ear receives the processed signals and converts the processed signals back as amplified audio output signals, which correspond to the sound waves received by the microphone earpiece 10. The microphone and the receiver of the hearing aid system 1 are physically separated far apart and thus completely eliminate both mechanical and acoustic feedback.

In another embodiment, the hearing aid system 1 is configured to receive sounds from both the microphone earpiece 10 and the process unit 20, as shown in FIG. 1B, to allow the hearing aid user to select the source of the sound signals in various environments, such as a conversation, a meeting, a concert, TV, or a movie. The sound signals from the process unit 20 may come from multiple sources, including a built-in microphone on the process unit 20 or an external microphone connected to the process unit 20 through an input port or wirelessly.

In still another embodiment, the hearing aid system 1 is configured as a communication device such as a telephone (FIG. 1C). The receiver earpiece 30 is used as the receiver of the communication device and the process unit 20 is used as a mouthpiece through a built-in output microphone or an external output microphone connected to the process unit 20 through an input port or wireless.

In an alternative embodiment, the hearing aid system 1 is configured as a playback device (FIG. 1D). The sound signals are generated from the process unit 20 internally or externally. Internal signal sources include sound signals stored in a storage device in the signal process unit 20, generated by programs in the process unit 20, such as white noise as a relieve for tinnitus, or combinations thereof. External signal sources include a music player (CD, DVD, MP3, etc.), a radio receiver, a television, and a network such as intranet and internet. The microphone earpiece 10 also functions as a receiver to receive processed signals, which may be different from the processed signals received by the receiver earpiece 30, directly from the process unit and thus enables the hearing aid user to hear in both ears. Alternatively, the hearing aid system contains a second output receiver earpiece 30 and the microphone earpiece 10 is simply replaced with the second receiver earpiece 30 when the hearing aid is used as a playback device. A stereo sound effect can also be generated by synchronizing the sound signals on these two receivers 30.

The embodiments for each component of the hearing aid system of the present invention are exemplified below. However, the particular implementations shown and described herein are for illustrative purposes only and are not intended to otherwise limit the scope of the present invention in any way. For the sake of brevity, conventional electronics, such as electronic circuitries with a variety of functionalities, control systems, software development and other functional aspects of the systems, including components of the individual operating components of the systems, may not be described in detail. Furthermore, the connecting lines, or connectors shown in the various figures in the present invention are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in the art without departing from the spirit and scope of the present invention

Input Microphone Earpiece 10:

The input microphone earpiece 10 of the present invention contains at least one microphone for receiving audio signals, a power supply, one on/off switch device, and a signal transmission device for signal transmission between the microphone earpiece 10 and the portable signal process unit 20. Preferably, all components in the microphone earpiece 10 are miniaturized so that the microphone earpiece 10 can be built small enough to fit in an ear of a hearing aid user if desired. Suitable power supplies for the microphone earpiece 10 include any standard power supply, such as a battery, preferably a miniature battery. In case that the microphone earpiece 10 and the process unit 20 is wire connected, the power for the microphone earpiece 10 is preferably supplied by a battery, the process unit 20, or a combination thereof. Nonlimiting examples of the on/off device on the microphone earpiece 10 include a simple on/off switch, an on/off circuitry controlled remotely through the process unit 20, and a combination thereof. The microphone of the microphone earpiece 10 converts the sound signals into transmittable signals representing the received audio signals.

When the hearing aid system 1 is operated in a digital mode, such as digital signal transmission, digital signal process, or both, the hearing aid system 1 also contains an A/D converter to digitalize the audio signals or the transmittable signals. In one aspect, the A/D converter is integrated into the microphone earpiece 10. In another aspect, the A/D converter is integrated into the signal process unit 20. It is advantageous to integrate the converter into the process unit 20 so that the microphone earpiece 10 is lighter and has longer battery life.

The signal transmission device is used to transfer signals and data between the input microphone earpiece 10 and the signal process unit 20. In one aspect, the signal transmission device is a communication circuitry for establishing and maintaining a wireless communication link with the process unit. In another aspect, the signal transmission device is a wire, which physically connects the earpiece 10 and the process unit 20, and through which the signals are transferred between them. Multiple signal transmitting formats are suitable for the present application, including electronic, electromagnetic, optical, and others. The signal transmission device is either single- or bidirectional. In a bidirectional communication, both signals such as control commands, and data such as operational parameters, may be transmitted between the microphone earpiece 10 and the process unit 20.

In one embodiment, the microphone earpiece 10 contains one microphone. Nonlimiting examples for the microphone include omnidirectional and directional. A directional microphone is particularly useful for a hearing impaired person in noisy or reverberant environments, such as church or restaurants.

In another embodiment, the microphone earpiece 10 contains an omnidirectional microphone and a directional microphone. An additional switch device is also provided to toggle between these two microphones. The switch device is a physical switch located on the earpiece 10, a switch circuitry controlled remotely through the process unit 20, or a combination thereof. The microphone earpiece 10, the process unit 20, or both may also contain an indicator for indicating the status of selection.

In yet another embodiment, the microphone earpiece 10 contains two directional microphones in a configuration, for example, such as that one microphone is directed to the front and the other is directed to the rear of the hearing impaired person. Thus, the front microphone selectively receives front audio signals and the rear microphone selectively receives rear audio signals. However, the present invention is not limited in any ways to the particular configuration illustrated hereinabove. Other configuration, such as a combination of front and side microphones, and a combination of side and rear microphone, is equally applicable. The microphone earpiece 10, the process unit 20, or both may also contain an indicator for indicating the status of selection. The hearing aid system 1 also contains an additional switch with two stages (“toggle switch”) to toggle between the microphones or with three stages to select among the first microphone, the second microphone, or both. The switch may be a physical switch located on the earpiece 10, a switch circuitry remotely controlled by the process unit 20, or a combination thereof.

The wireless communication circuitry of this embodiment, if required, is preferably a multi-channel communication circuitry so that the audio signals obtained from both microphones can be transmitted to the process unit 20 independently for data processing.

In certain embodiments, the microphone earpiece 10 further contains a receiver for delivering audio signals to the same ear that wears the microphone earpiece 10 so that the hearing aid user can hear in both ears. A stereo sound effect can also be generated by synchronizing the two receivers. Unlike a conventional hearing aid, however, the receiver does not receive sound signals from the microphone embedded in the earpiece 10. The receiver is designed to receiver audio signals from an external source or a built-in microphone in the signal process unit. The term “external signals” used herein refers to the signals generated by the process unit from an external source, including an external microphone, a telephone, a cellular phone, a wireless phone, TV, a DVD or CD player, PDA, etc. The receiver receives audio signals from an external source directly or through the signal process unit 20.

Preferably, the microphone earpiece 10 contains an additional switch with two stages (“toggle switch”) to toggle between the microphone and receiver. The switch is a physical switch located on the earpiece 10, a switch circuitry remotely controlled by the process unit, or a combination thereof. The switch may also be an automatic toggle switch circuitry, which automatically turns the microphone off when external signals are detected and turns the microphone back on when external signals are absent. In addition, the microphone earpiece 10 also contains a volume controlling device, which is a volume controller, such as a potentiometer, on the microphone earpiece 10, a volume controlling circuitry, or a combination thereof. Preferably, the microphone earpiece 10 is a volume controlling circuitry which is remotely controlled through the process unit 20. The volume of the receiver on the microphone earpiece 10 is controlled independently from that of the receiver on the receiver earpiece 30.

The microphone earpiece 10 of the present invention is not limited to any particular style. The microphone earpiece 10 can be in a variety of styles, including Behind-The-Ear (“BTE”), In-The-Ear (“ITE”), In-The-Canal (“ITC”), Completely-In-the-Canal (“CIC”), and a combination thereof. Some further examples of hearing aid styles and variations are disclosed in U.S. Pat. No. 6,940,988, which is hereby incorporated into the present application by reference. Because of the physical separation of the microphone earpiece 10 and the receiver earpiece 30, the hearing aid system 1 of the present invention does not have stringent fitting requirements for the earpieces as these all-in-one hearing aid devices. Therefore, any style of earpiece which is able to deliver sounds in good quality and to provide adequate wear comfort is suitable for the present invention, including the styles of conventional earphones and headphones.

The microphone earpiece 10 of the present invention is also not limited to any particular location relative to the wearing ear. As long as in an appropriate proximity to the wearing ear to deliver its desired functionalities, the earpiece can be deposited at any place with a design possibility without scarification of its desired functionalities and wear comfort to a hearing aid user.

Output Receiver Earpiece 30:

In one embodiment of the present invention, the output receiver earpiece 30 contains a receiver for delivering amplified audio signals to the impaired ear of the hearing impaired individual, a power supply, an on/off switch device, and a signal transmission device for signal transmission between the output receiver earpiece 30 and the portable signal process unit 20. Preferably, all components in the receiver earpiece 30 are miniaturized so that the earpiece 30 can be built small enough to fit into the ear of a hearing aid user if desired. Suitable power supply for the receiver earpiece 30 includes any standard power supply, such as a battery, preferably a miniature battery. In case that the receiver earpiece 30 and the process unit 20 is wire connected, the power for the receiver earpiece 30 is supplied by a battery, the process unit 20, or a combination thereof. The on/off switch device on the earpiece 30 is a simple on/off switch, an on/off circuitry controlled remotely through the process unit 20, or a combination thereof.

The signal transmission device is primarily used to transfer signals between the receiver earpiece 30 and the signal process unit 20. In one aspect, the signal transmission device is a communication circuitry for establishing and maintaining a wireless communication link with the process unit 20. In another aspect, the signal transmission device is a wire, which physically connects the earpiece 30 and the process unit 20, and through which the signals are transmitted between them. As discussed herein above, multiple signal transferring formats are suitable for the present application. The signal transmission device is either single- or bidirectional, preferably bidirectional. In a bidirectional communication, both signals such as control commands and data such as operational parameters can be transferred between the receiver earpiece 30 and the process unit 20.

In addition, the receiver earpiece 30 also has a volume controlling device, which is be a volume controller, such as a potentiometer, on the receiver earpiece 30, a volume controlling circuitry, or both. Preferably, the receiver earpiece 30 is a volume controlling circuitry remotely controlled through the signal process unit 20. Optionally, the receiver earpiece 30 can also have a storage device for data storage.

In another embodiment, the output receiver earpiece 30 further contains a telecoil (“T”-coil), which is an induction coil containing a metal rod encircled by many turns of a metal wire, such as copper. For example, a telecoil is able to receive magnetic fields generated by telecoil-compatible telephones. The receiver earpiece 30 also contains an additional switch with two stages to toggle between the receiver and telecoil, or with three stages to select among the receiver, the telecoil, and both. The additional switch may be a simple switch on the earpiece 30, a switch circuitry controlled remotely through the process unit 20, or a combination thereof. The receiver earpiece 30, the process unit 20, or both may also contain an indicator for indicating the status of selection. When a hearing aid is switched to the telecoil, the telecoil is set to detect only an electromagnetic field. The strength of the electrical current “induced” in the telecoil by the electromagnetic field is directly proportional to both the energy in the magnetic field and to the relative positions of the induction coil in the hearing aid to the magnetic field. Telecoils may also be used in any setting that provides an induction loop assistive listening system. In such a system, for example, a loop of wire around a room produces an electromagnetic field instead of, or in conjunction with, amplified sound from the receiver.

As described hereinabove for the microphone earpiece 10, the receiver earpiece 30 of the present invention is also not limited to the style and the location of the earpiece relative to the wearing ear. The receiver earpiece 30 can have a variety of styles, including Behind-The-Ear (“BTE”), In-The-Ear (“ITE”), In-The-Canal (“ITC”), Completely-In-the-Canal (“CIC”), and a combination thereof. Due to its special design features, the hearing aid system of the present invention does not have stringent fitting requirements for the earpieces to avoid mechanical and acoustic feedback, as conventional hearing aid devices. Any style of earpiece which is able to deliver sounds in good quality and to provide adequate wear comfort can be used in the present invention, including these of conventional earphones and headphones, and style variations of commercial hearing aids. As long as in an appropriate proximity to the wearing ear, the earpiece can be deposited at any place with a design possibility without scarification of its desired functionalities and wear comfort to a hearing aid user.

Signal Process Unit 20:

The signal process unit 20 contains a signal transmission device, a signal processor, a power supply, an on/off switch, and a plurality of inputs. The signal process unit 20 is not limited to any particular shape and size. Preferably, the process unit 20 is portable and with a size of smaller than a normal shirt pocket so that a hearing aid user can carry it around easily. Suitable power supply for the receiver earpiece 30 includes any standard power supply, such as a battery, an AC/DC transformer, or a combination thereof. Optionally, the signal process unit 20 also contains a charge port for charging the battery. In one aspect, the on/off switch is a simple on/off switch which controls only the process unit. In another aspect, the on/off switch also contains an electronic circuitry which enables the process unit 20 to control the microphone earpiece 10 and the receiver earpiece 30 as well. The signal process unit 20 may also contain an indicator for indicating the status of the system.

The inputs of the process unit 20 include analog inputs, digital inputs, and one or more input devices (e.g., a trimmer, a pushbutton switch, etc.). These inputs enable the process unit 20 to receive both digital and analog signals from a variety of sources, including an external microphone, a music player (e.g., cassette, CD, DVD, MP3, etc.), a communication device (e.g., telephone, cordless phone, cellular phone, black berry, etc.), a radio receiver, a television, a computer, and other external devices. Nonlimiting example of inputs including analog audio ports, data ports (e.g., USB ports, serial ports, parallel ports, and IEEE 1394), communication ports (e.g., telephone, cable, and network), adaptors for data storage devices (e.g., a hard disk, a floppy disk, CD-ROM, DVD-ROM, and flash memories), and combinations thereof.

The signal transmission device on the signal process unit 20 is primarily used to communicate with both the microphone earpiece 10 and receiver earpiece 30. In one aspect, the transmission device is a multi-channel communication circuitry for establishing and maintaining wireless communication links individually or simultaneously with the microphone earpiece 10, the receiver earpiece 30, and other external devices and user interfaces, such as, for example, an external microphone, a music player (e.g., cassette, CD, DVD, MP3, etc.), other communication devices (e.g., telephone, cordless phone, cellular phone, black berry, etc.), a radio receiver, a television, a computer, and other external devices. The wireless communication with an external device is readily established using standard communication protocols such as wireless LAN, Bluetooth, or infrared. In another aspect, the transmission device is wires, which physically connects the microphone earpiece 10 and the receiver earpiece 30 to the process unit 20. The wires transfer signals between the process unit 20 and the earpieces, and can also be used to supply power to the microphone earpiece 10 and the receiver earpiece 30 from the process unit 20. The communication circuitry is either single- or bidirectional, preferably bidirectional. In a bidirectional communication, both signals such as control commands and data such as operational parameters can be transferred between the process unit 20 and the earpieces and other external devices and user interfaces.

In certain embodiments of a wireless communication, the frequency channel and/or the frequency band (e.g., UHF, ISM, etc.) used by the communication circuitry is also be programmable. In such case, the communication circuitry automatically selects the clear frequency channel for a low-noise wireless communication with the earpieces. For example, a clear channel selection program executed by the processor may cause the communication circuitry to sweep through the operating frequency band to identify a quiet frequency channel, and then set the communication circuitry to operate using the identified quiet channel. A clear channel may be selected, for example, by measuring a noise level at each frequency in the band, and then selecting the frequency channel with the lowest noise level. In another example, the clear channel selection program may only sweep through frequencies in the operating band until a frequency channel is identified having a noise level below a pre-determined threshold, and then set the communication circuitry to operate using the identified channel. A frequency band sweep may be initiated, for example, by a user input (e.g., depressing a button), by detecting that the noise level of a currently selected channel has exceeded a pre-defined threshold level, or by some other initiating event. The noise level of a channel may, for example, be measured by an RSSI process in the processor, by a frequency synthesizer and channel signal strength detector included in the communication circuitry, or by some other means. The noise level of a communication channel may include environmental noise, cross-talk from other channels, and/or other types of unwanted disturbances to the transmitted signal. Additionally, the multi-channel communication circuitry may also support functions such as stereo transmission, multi-language transmission, or others. For example, the communication circuitry may transmit stereo audio to both the microphone earpiece 10 with a receiver and the receiver earpiece 30 on two channels, one channel for each earpiece.

The user interface, such as a computer and a portable programmer, can be readily connected to the process unit 20 either through the inputs or wirelessly through the communication circuitry. The user interface can be used to program and/or control the operation of the hearing aid system. For example, a user interface may be used by an audiologist or other person to program the hearing aid instrument for the particular hearing impairment of the hearing instrument user, to switch between hearing instrument modes (e.g., bi-directional mode, omni-directional mode, etc.), to download data from the hearing instrument, or for other purposes. In another example, the user interface may be used to select the frequency channel and/or frequency band used for wireless communications between the earpieces 10 and 30 and processor unit 20. In addition, the processor unit functionality may be embedded as a part of a larger system, such as a cellular telephone, to enable direct communication to a hearing instrument.

The signal processor of the process unit 20 is to process the electronic signals received from the microphone earpiece 10, a built-in microphone on the process unit 20, or other external devices and user interfaces. In one embodiment, the signal processor is an analog amplifier. It may also contain a preamplifier. In another embodiment, the signal processor is a programmable analog amplifier, which will automatically adjust volume based on the level of the incoming sound. A programmable analog amplifier is much more adaptable to a hearing aid user's profile than a simply analog amplifier. Typically, a programmable amplifier makes soft sounds louder and loud sounds softer. The signal processor may also contain a preamplifier, an equalizer, and a data storage device.

In yet another embodiment, the signal processor is a digital sound processor (“DSP”), also known as a digital playback device. In addition to the standard functions, such as signal decompression and decoding, error detection, and synchronization, the digital signal processor can provide a variety of advanced functionalities for signal processing, including directional processing, multiple channel compression, noise reduction, and clear channel searching. The digital sound processor can also run multiple programs simultaneously to dynamically adjust the setting of the hear aid system to various sound environments, such as crowded restaurants or stores, using spectral analysis to determine appropriate settings.

In yet another embodiment, the signal processor is also provided the abilities to generate accurate sound signals for a hearing test. The sound signals generated include those typically administered by an audiologist. The hearing test can be performed by the user or other people such as a specialist. The frequency and loudness of the signal are calibrated and controlled to establish optimal hearing profile for a hearing aid user. The hearing profile is then stored electronically in a storage device in the process unit 20, which is subsequently used as a reference to compensate the hearing impairment of the hearing aid user. The hearing test also includes speech-in-noise (SIN) and other standard audio recognition tests. According to the hearing test results, the corrective adjustment is programmed and stored in the storage device to aid the hearing of the user.

Alternatively, all hearing tests can also be executed with an external device or user interface, such as a computer and a portable programmer, which connects to the process unit 20 wirelessly or through an input port. After the hearing test, the optimal hearing profile and other operational parameters are downloaded to and stored in the storage device in the signal process unit 20. The process unit may also contain a series of common hearing profiles so that a hearing aid user can quickly select the appropriate hearing compensating profile through trial-and-error without taking a hearing test.

The signal process unit 20 can also contain other components and devices commonly used in the arts, such as a storage device. The storage device can be any standard storage device, such as a hard disk, a floppy, ROM, PROMs (programmable read-only memory), EPROMs (erasable read-only memory), EEPROMs (electrically erasable programmable read-only memory), and a common variation of EEPROMs called “flash memory”. The storage device can also be permanent or removable. The information stored in the storage device includes, for example, operational parameters, multiple personal fitting programs “prescribed” to the hearing needs of a particular hearing impaired individual, diagnostic programs and sounds, music files, and others. The signal process unit may also contain a built-in microphone. This design allows a hearing aid user, with an additional switch, to select an appropriate microphone to receive audio signals proximate to the signal sources such as conversations, meetings, concerts, TV or movies.

The present invention has been described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The examples set forth above are provided to give those of ordinary skill in the art with a complete disclosure and description of how to make and use the preferred embodiments of the systems, and are not intended to limit the scope of what the inventor regard as his invention. Modifications of the above-described modes for carrying out the invention that are obvious to persons of skill in the art are intended to be within the scope of the following claims. All publications, patents, and patent applications cited in this specification are incorporated herein by reference as if each such publication, patent or patent application were specifically and individually indicated to be incorporated herein by reference.

What is claimed is:

1. A hearing aid system free of mechanic or acoustic feedback for a hearing impaired individual with a predetermined hearing profile, comprising
a microphone earpiece attached to the first ear of the hearing impaired individual for receiving audio signals to generate transmittable signals;
a portable signal process unit for receiving and processing the transmittable signals to generate processed signals according to the predetermined hearing profile; and
a receiver earpiece attached to the second hearing impaired ear of the individual for receiving the processed signals from the portable signal process unit and generating amplified audio signals to compensate the hearing impairment of the individual.

2. The hearing aid system of claim 1, wherein the microphone earpiece comprises at least one microphone for receiving audio signals, a power supply, an on/off switch device, and a signal transmission device for signal transmission between the microphone earpiece and the portable signal process unit.

3. The hearing aid system of claim 2, wherein the on/off switch device is a switch or a circuitry that is remotely controlled via the portable signal process unit.

4. The hearing aid system of claim 2, wherein the signal transmission device is a communication circuitry to transmit the transmittable signals wirelessly between the microphone earpiece and the portable signal process unit.

5. The hearing aid system of claim 2, wherein the microphone earpiece contains one microphone that is omnidirectional or directional.

6. The hearing aid system of claim 2, wherein the microphone earpiece contains a first and second microphone.

7. The hearing aid system of claim 6, wherein the microphone earpiece further comprises a toggle switch to switch between the first and second microphone.

8. The hearing aid system of claim 2, wherein the microphone earpiece further comprise a receiver for receiving signals from the signal process unit, whereby the receiver and the microphone do not work at the same time to eliminate mechanical and acoustic feedbacks.

9. The hearing aid system of claim 2, wherein the microphone earpiece further comprise a volume controlling device.

10. The hearing aid system of claim 2, wherein the microphone earpiece further comprises an A/D converter for digitalizing the audio signals or the transmittable signals.

11. The hearing aid system of claim 1, wherein the receiver earpiece comprises a receiver for delivering the amplified audio signals to the hearing impaired individual, a power supply, an on/off switch device, and a signal transmission device for signal transmission between the receiver earpiece and the portable signal process unit.

12. The hearing aid system of claim 11, wherein the on/off switch device is a switch or a circuitry that is remotely controlled via the portable signal process unit.

13. The hearing aid system of claim 11, wherein the signal transmission device is a communication circuitry to transmit the processed signals wirelessly between the receiver earpiece and the portable signal process unit.

14. The hearing aid system of claim 11, wherein the receiver earpiece further comprises a telecoil for receiving magnetic signals from a telecoil-compatible telephone.

15. The hearing aid system of claim 1, wherein the signal process unit comprises a signal transmission device for signal transmission between the portable signal process unit, and the receiver earpiece and the microphone earpiece, a signal processor for signal processing according to the predetermined hearing profile, a power supply, and an on/off switch.

16. The hearing aid system of claim 15, wherein the signal processor is an analog amplifier or digital sound processor.

17. The hearing aid system of claim 16, wherein the signal process unit further comprises a storage device for storing the hearing profile of the hearing impaired individual or hearing testing programs.

18. The hearing aid system of claim 15, wherein the signal process unit further comprises at least one input for communicating with an electronic device.
